(19) United States
(12) Patent Application Publication
(10) Pub. No.: US 2019/0113742 A1
(43) Pub. Date: Apr. 18, 2019

(54) VIEWING DEVICE FOR A MOTOR VEHICLE

(71) Applicant: Valeo Systèmes d'Essuyage, Le Mesnil Saint Denis (FR)

(72) Inventors: Vincent Gaucher, Le Mesnil Saint Denis (FR); Stéphane Houssat, Issoire (FR); Eric Poton, Issoire (FR)

(73) Assignee: Valeo Systèmes d'Essuyage, Le Mesnil Saint Denis (FR)

(21) Appl. No.: 16/090,093

(22) PCT Filed: Mar. 14, 2017
(86) PCT No.: PCT/EP2017/056024

§ 371 Date: Sep. 28, 2018

(30) Foreign Application Priority Data
Mar. 30, 2016 (FR) 1652706

(51) Int. Cl. G02B 27/00; B60S 1/56; B60R 1/12

(52) U.S. Cl. CPC G02B 27/0006; B60R 2001/1253; B60R 1/12; B60S 1/566

(57) ABSTRACT

The present invention relates to a viewing device (1) for a motor vehicle (100), comprising:
an image sensor (3),
an optical conduit (5) defining an optical input path for light rays,
a reflective element (7) placed so as to reflect the light rays transmitted via the optical conduit (5) towards the image sensor (3), the optical axis (D1) of the image sensor (3) being angularly offset from the optical axis (D2) defined by the optical conduit (5),
   wherein the reflective element (7) is mounted so as to be movable, and the viewing device (1) further comprises a unit (9) for driving the movement of the reflective element (7), the movement of the reflective element (7) by the drive unit (9) causing the cleaning of said reflective element (7).

The present invention relates to a viewing device for a motor vehicle.

At the present time, cameras are commonly used on motor vehicles to improve the user's view of the vehicle environment; notably, rear view cameras are used to facilitate the manoeuvring of the vehicle. These cameras may form part of a parking assistance system, enabling a driver to park more easily in a parking space without turning his head, and to detect obstacles located behind the vehicle.

For this purpose, there are known cameras which are installed inside the passenger compartment against the rear window, with a view to the rear from the rear window of the vehicle. These cameras are well protected from external climatic effects and may, for example, benefit from rear window de-icing and cleaning systems such as a heating wire integrated into the rear window glazing.

However, the viewing angle is not optimal, notably for parking assistance, and for this reason it is preferable for the camera to be placed at the rear bumper or at the rear number plate of the vehicle.

In this case, the camera is highly exposed to projections of dirt that may be deposited on its lens, thus reducing its effectiveness or even rendering it inoperative.

In particular, in rainy weather, there may be projections of rain and dirt that may greatly affect the operability of the viewing system.

To counteract the deposition of dirt on the camera, there is a known way of arranging a device for cleaning the camera lens, usually a cleaning liquid spray located near the camera, for eliminating contaminants that are deposited over time.

However, the camera lens, which is a relatively fragile component, is not protected against projections that may damage it.

There is also a known way of mounting the camera inside an outer casing of the vehicle and protecting it from external impact by means of protective glazing attached to the casing. However, this makes it necessary to use a device, such as a windscreen wiper, for cleaning the protective glazing, which interferes with the camera's field of view during its use.

It will therefore be useful to propose a viewing device which enables the camera to be protected from any projections, while minimizing the interference caused by the cleaning of the camera protection elements.

For this purpose, the present invention relates to a viewing device for a motor vehicle, comprising:
an image sensor,
an optical conduit defining an optical input path for light rays,
a reflective element placed so as to reflect the light rays transmitted via the optical conduit towards the image sensor, the optical axis of the image sensor being angularly offset from the optical axis defined by the optical conduit,
   wherein the reflective element is mounted so as to be movable, and the viewing device further comprises a unit for driving the movement of the reflective element, the movement of the reflective element by the drive unit causing the cleaning of the reflective element.

By using a movable reflective element to reflect the light rays towards the image sensor, it is possible, on the one hand, to position the image sensor so that it is protected from any external projections, and, on the other hand, to allow the reflective element to be cleaned without any interference with the viewing quality for the user of the device.

According to an example of the present invention, the reflective element is mounted so as to be movable in rotation or in translation, with a reciprocating motion.

According to an optional aspect of the present invention, the reflective element is more extensive than the area of reflection of the light rays that have passed through the optical conduit, and the viewing device comprises an element for cleaning the reflective element, said cleaning element being configured to clean the reflective element outside said area of reflection.

By using a reflective element that is more extensive than the area of reflection of the light rays that have passed through the optical conduit, it is possible to put the cleaning elements in contact with the reflective element outside the area of reflection, so that this does not interfere with the quality of the user's view.

In an example of embodiment of the present invention, the cleaning element is positioned to be lower than the area of reflection when the viewing device is in the mounted state on the motor vehicle.

The lower position of the cleaning element enables soiling and/or cleaning liquid to be removed by gravity without any risk of affecting the reflection area.

According to another example of the present invention, the reflective element has the general shape of a disc, and the drive unit is configured to drive the reflective element in rotation around a central axis of the disc.

A disc shape makes it possible to limit the overall dimensions and simplify the rotary drive.

According to a further example of the present invention, the cleaning element comprises at least one element from among:
a scraper designed to come into contact with a portion of the reflective element,
a brush designed to come into contact with a portion of the reflective element,
a device for projecting compressed air on to a portion of the reflective element,
a device for projecting cleaning liquid.

According to an additional example of the present invention, the reflective element comprises a hydrophobic treatment and the drive unit is configured to rotate the reflective element so as to clean any soiling from the reflective element by centrifugal force.

According to another example of the present invention, the optical conduit has a generally flared shape, notably a substantially conical shape.

The flared shape of the optical conduit enables a wider viewing angle to be obtained.

According to a further example of the present invention, the surface of the reflective element has a curvature configured to increase the field of view of the image sensor.

According to another example of the present invention, the drive unit is configured to move the reflective element when the viewing device is activated or when a dedicated command is activated by the user.

According to another example of the present invention, the viewing device comprises a unit for processing the image detected by the image sensor, configured to detect soiling on the reflective element and to cause the drive unit to be activated to put the reflective element into motion when soiling is detected.

By using an image processing unit to activate the drive unit, it is possible to limit the use of the drive unit and consequently the power consumption of the viewing device.

According to an additional aspect of the present invention, the reflective element and the image sensor are arranged so that the light rays are reflected upwards when the viewing device is in the mounted state in the vehicle.

The upward reflection prevents soiling from affecting the image sensor.

According to another example of the present invention, the image sensor comprises an infrared sensor and provides night vision.

The present invention also relates to a motor vehicle comprising at least one viewing device as described above.

According to another example of the present invention, the viewing device is a rear view device coupled to a device for engaging the reverse gear of the vehicle, the viewing device being activated when the reverse gear is engaged.

According to a further example of the present invention, the viewing device is, notably, a rear view device located on a side of the vehicle or on a rear opening such as the rear door of a van or on a trailer, such as a trailer of an articulated vehicle, or on a caravan.

Other characteristics and advantages of the invention will be apparent from the following description, provided by way of non-limiting example, with reference to the attached drawings, in which:

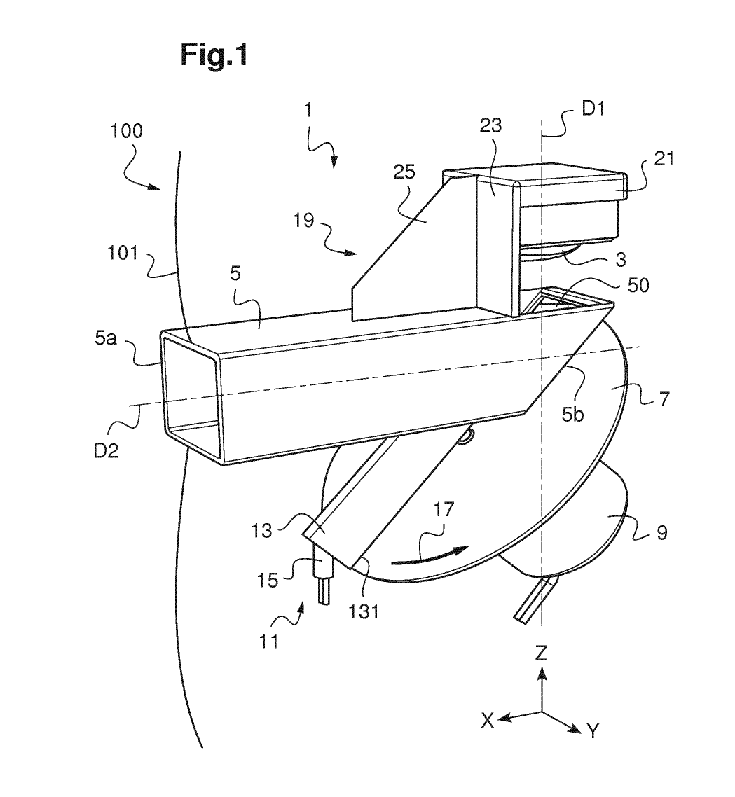

FIG. 1 shows a simplified diagram of a first embodiment of a viewing device according to the present invention;

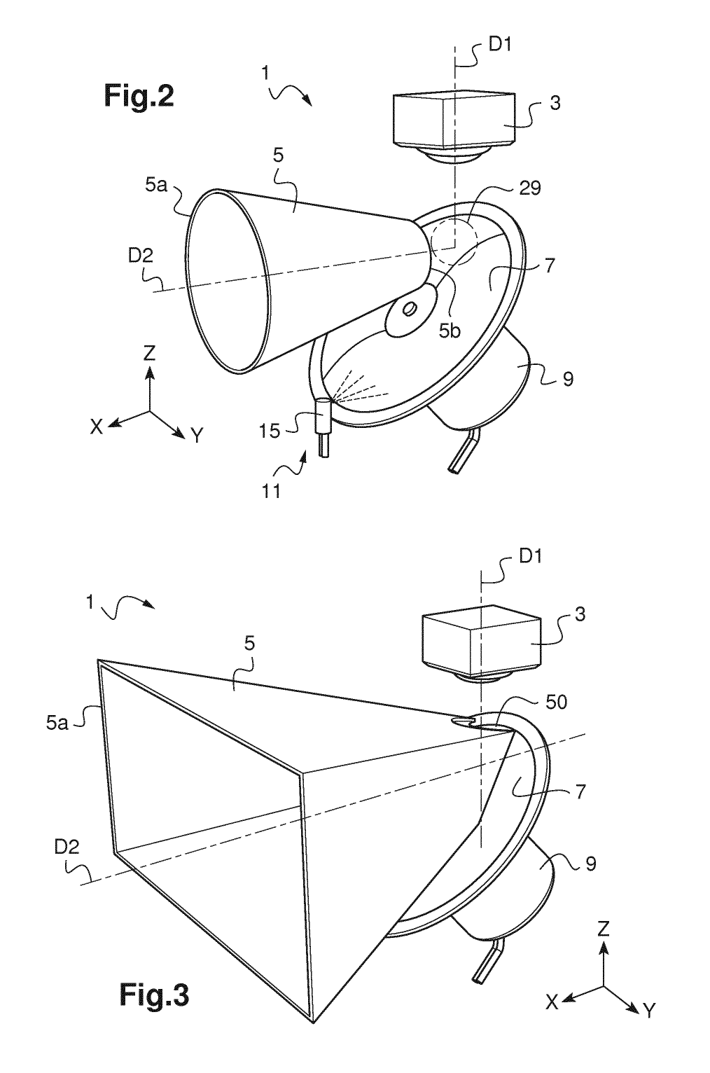

FIG. 2 shows a simplified diagram of a second embodiment of a viewing device according to the present invention;

FIG. 3 shows a simplified diagram of a third embodiment of a viewing device according to the present invention;

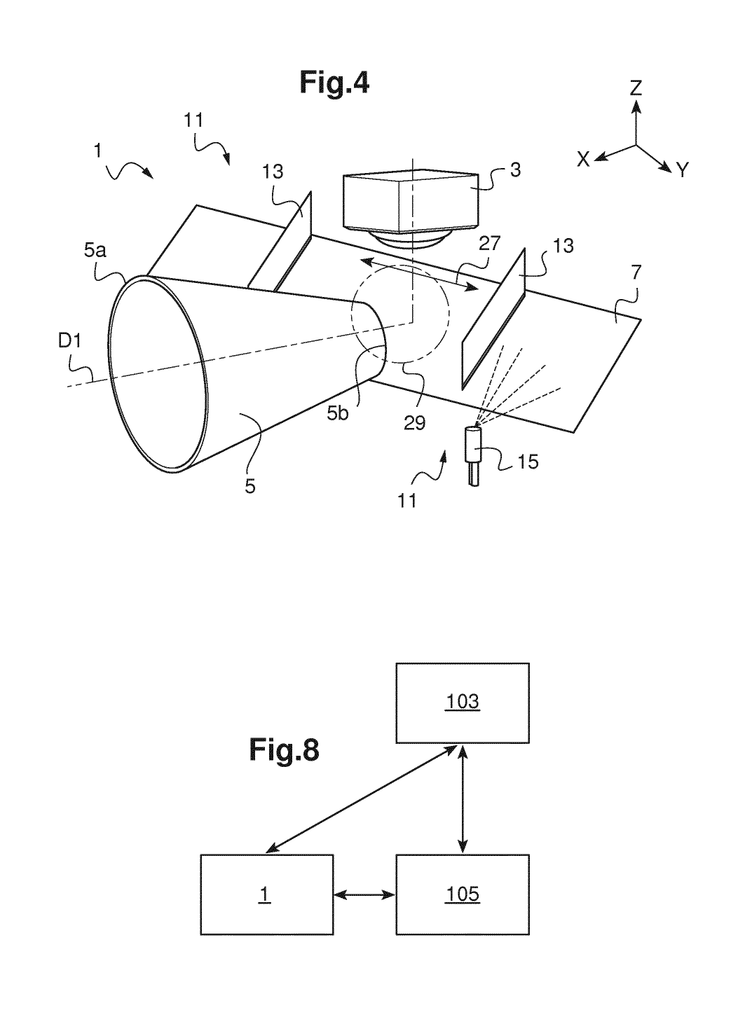

FIG. 4 shows a simplified diagram of a fourth embodiment of a viewing device according to the present invention;

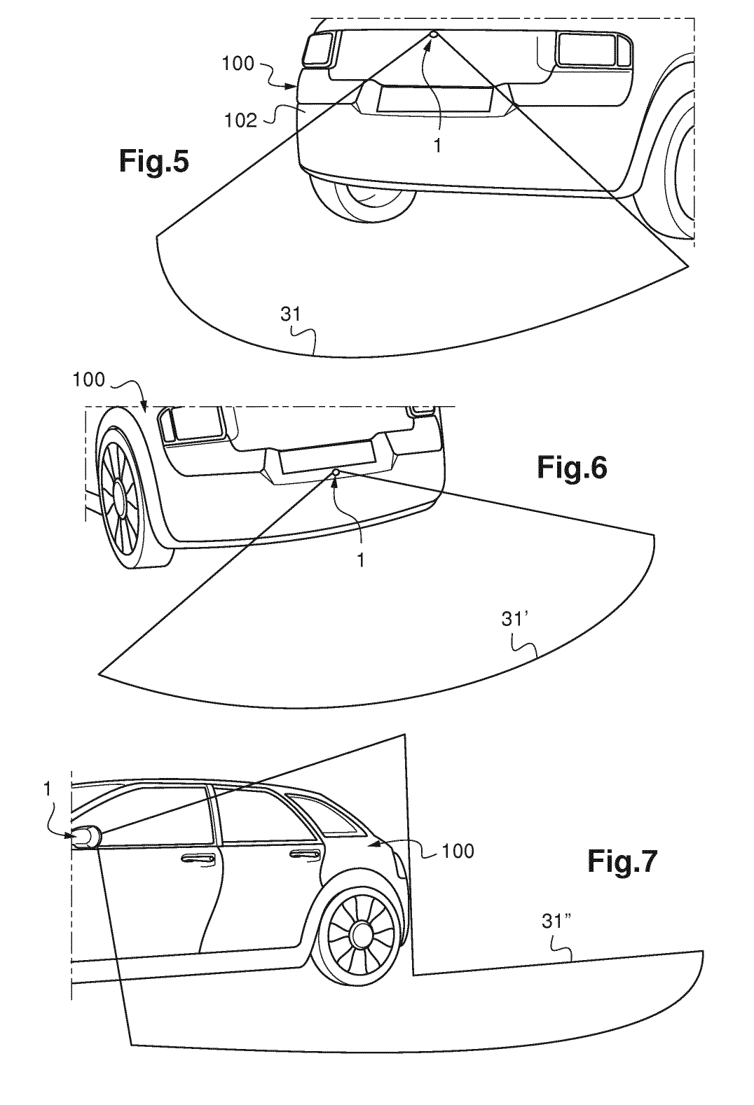

FIG. 5 shows a simplified diagram of a motor vehicle comprising a viewing device located in a first position;

FIG. 6 shows a simplified diagram of a motor vehicle comprising a viewing device located in a second position;

FIG. 7 shows a simplified diagram of a motor vehicle comprising a viewing device located in a third position;

FIG. 8 shows a diagram schematically representing a viewing device coupled to a device for engaging reverse gear.

In all the figures, elements having the same functions are given the same reference numerals.

The following embodiments are examples. Although the description refers to one or more embodiments, this does not necessarily mean that each reference concerns the same embodiment, or that the characteristics are applicable to a single embodiment only. Simple characteristics of different embodiments may also be combined or interchanged to provide other embodiments.

### FIRST EMBODIMENT

FIG. 1 shows a first embodiment of a viewing device 1 for a motor vehicle 100 according to the present invention. This viewing device 1 is designed to be installed, for example, on a bodywork element 101 as shown schematically in FIG. 1, or on an external element such as a rear view mirror, for the purpose of observing the environment of the motor vehicle 100, as explained below.

The viewing device 1 is, for example, associated with a display screen, for example a Trinitron flat tube (TFT), a liquid crystal (LCD) or light-emitting diode (LED) screen, positioned on the dashboard or central console of the motor vehicle 100, for displaying the images detected by the viewing device 1. The display may also be provided by projection on to an element, notably a transparent element, for example on the windscreen or a glazing unit of the motor vehicle 100.

The viewing device 1 comprises an image sensor 3 or a view recording device in the form of a camera, for example, or any other type of image sensor 3 that can be used to detect an image associated with the field of view of the viewing device 1.

In particular, the image sensor 3 may comprise an infrared sensor providing night vision. Alternatively, the image sensor 3 may comprise an infrared sensor coupled to a visible field sensor.

The optical axis of the image sensor 3 is orientated in a first direction denoted D1, which may be substantially vertical, the image sensor 3 being aimed downwards, for example, when it is in the mounted state in the motor vehicle 100. This makes it possible to prevent the deposition of dust or soiling on the lens of the image sensor 3.

The viewing device 1 also comprises an optical conduit 5 and a reflective element 7. The optical conduit 5 and the reflective element 7 are positioned upstream of the image sensor 3 relative to the direction of the light rays in the viewing device 1, the optical conduit 5 being placed upstream of the reflective element 7.

The optical conduit 5 forms an input optical path along which the light rays from the field of view of the viewing device 1 are received. The light rays are then reflected by the reflective element 7 so as to be transmitted to the image sensor 3.

The optical axis of the optical conduit 5 follows a second direction denoted D2, which is different from the first direction D1. The direction D2 is, for example, substantially horizontal when the optical conduit 5 is in the mounted state in the motor vehicle 100. The optical axis D1 of the image sensor 3 is therefore angularly offset from the optical axis D2 of the optical conduit 5. In the present example, this offset is about 90°, but other angles may be used, depending, notably, on the available mounting space for the viewing device 1.

In the present example of embodiment, the optical conduit 5 has a generally tubular shape, with a square cross section. However, cross sections of other shapes, notably round, may also be used in the context of the present invention.

The optical conduit 5 comprises a first end denoted 5a, forming the input of the viewing device 1, through which the light rays enter the optical conduit 5, and a second end 5b, opposed to the first end 5a. The inner wall of the optical conduit 5 is, for example, made of a non-reflective or possibly absorbent material, in order to limit the presence of parasitic reflections. The optical conduit 5 may, for example, be made of plastic material and may be, notably, black in colour.

The reflective element 7 is placed so as to reflect the light rays, received at the input of the viewing device 100 via the optical conduit 5 in the second direction D2, towards the image sensor 3 in the first direction D1.

The reflective element 7 may be formed by a metallic surface, notably a polished surface, made of aluminium for example.

The size of the reflective element 7 is greater than the area 29 (visible in FIGS. 2 and 4) of reflection of the light rays on the reflective element 7. The reflective element 7 extends, for example, over a surface area equal to at least twice the surface area of the reflection area 29. The reflective element 7 has, for example, the general shape of a disc, of which a portion corresponding to the reflection area 29 is positioned in the optical axis D2 of the optical conduit 5 and extends so as to reflect the light rays passing through the optical conduit 5 towards the image sensor 3.

Thus the viewing device 1 has the characteristics of a periscope, in which the light rays received through an optical conduit 5 are deflected by a reflective element 7 so as to be transmitted towards an image sensor 3. The reference frame X, Y, Z represents the longitudinal, transverse and vertical directions, respectively, of the motor vehicle 100, in such a way that FIG. 1 shows an example of the orientation of the viewing device 1 in the mounted state in the motor vehicle 100.

Regarding the optical conduit 5, the second end 5b of the optical conduit 5 may have a chamfered shape located near the reflective element 7 so that it fits against the shape of the reflective element 7, but without touching the latter. The optical conduit 5 may also comprise an opening 50 located in the direction D1, to allow light rays to pass towards the image sensor 3. In this case, the opening 50 has a square shape, but other shapes of the opening 50, rounded for example, may also be used.

Additionally, the viewing device 1 may comprise a support 19 for the image sensor 3, to ensure the correct positioning of the image sensor 3, notably relative to the reflective element 7. The support 19 is, for example, formed by a support casing 21 in which the image sensor 3 is positioned, and by a wall 23 connected, on the one hand, to the support casing 21 and, on the other hand, to the optical conduit 5, and extending parallel to the optical axis D1 of the image sensor 3. The support 19 may also comprise a reinforcing wall 25 which extends between the wall 23 and the optical conduit 5, to stiffen the support 19. The support 19 may be made in one piece with the optical conduit 5 and may be made together with the latter from plastic material, by moulding for example.

For cleaning the reflective element 7, the viewing device 1 also comprises a drive unit 9 for the reflective element 7 and a cleaning element 11 placed in contact with the reflective element 7 in an area of the reflective element 7 located outside the reflection area 29. In the present embodiment, the drive unit 9 is configured to make the reflective element 7 rotate about its axis of revolution and enable it to be cleaned by the cleaning element 11. The drive unit 9 comprises, for example, an electric motor for moving, and notably rotating, the reflective element 7.

The cleaning element 11 comprises, for example, a scraper 13 comprising a wiper blade 131 designed to come into contact with the surface of the reflective element 7 outside the reflection area 29 of the light rays. Thus the rotation of the reflective element 7 by the action of the drive unit 9 causes the reflective element 7 to be wiped by the wiper blade 131 of the scraper 13. The scraper 13 is, for example, made of plastic, and has, for example, an elongated shape, extending over at least a part of the radius of the disc forming the reflective element 7. The wiper blade 131 extends over at least a part of the length of the blade 13. The scraper 13 may be fixed to the optical conduit 5. The scraper 13 may also be made in one piece with the optical conduit 5. Only the wiper blade 131, designed to be in contact with the reflective element 7, may be made from another material, for example rubber or other material which is sufficiently flexible to allow effective wiping without damaging the reflective surface of the reflective element 7.

The cleaning element 11 may also comprise a cleaning liquid spray nozzle 15 to act in combination with the scraper 13. The nozzle 15 is placed so as to spray the cleaning liquid upstream of the scraper 13 in the direction of rotation of the reflective element 7. In the case of FIG. 1, the direction of rotation of the reflective element is indicated by the arrow 17.

The cleaning element 11, and notably the scraper 13, is located at a lower level than the reflection area 29 of the reflective element 7 when the viewing device 1 is in the mounted state in the motor vehicle 100, so that soiling and cleaning liquid may be removed from the reflective element 7 by gravity without any risk of affecting the reflection area 29.

Thus, in operation, the reflective element 7 is moved in rotation by the actuating unit 9, enabling the reflective element 7 to reflect the light rays transmitted through the optical conduit 5 towards the image sensor 3, while simultaneously being cleaned by the cleaning element 11. Thus any external projections are immediately cleaned off during the rotation of the reflective element 7, thus keeping a clean reflective surface in the reflection area 29 and providing correct reflection of the light rays towards the image sensor 3 and therefore a good quality of the images detected by the image sensor 3.

According to a first variant, the scraper 13 may be replaced with a brush or sponge or any other element for wiping the soiling from the surface of the reflective element 7.

According to a second variant, the scraper 13 may be replaced with a jet of compressed air, using a projection nozzle for example.

The projection of compressed air may be combined with the projection of cleaning liquid, so that two nozzles may be coupled to provide a projection of cleaning liquid and compressed air, the compressed air being applied downstream of the cleaning liquid in the direction of rotation 17 of the reflective element 7.

According to a third variant, the reflective element 7 may also be cleaned by a combination of hydrophobic treatment of the surface area of the reflective element 7 and the rotation of the reflective element 7 by the drive unit 9. This is because a fast rotation of the hydrophobically treated reflective element 7 may cause the ejection of any soiling present on the reflective element 7 due to the centrifugal force generated by the rotation of the reflective element 7. The rotation speed required to cause the ejection of the soiling may, for example, be predetermined, and the reflective element 7 may be constantly moved at this predetermined rotation speed during the use of the viewing device 1, or may be moved at this speed only at predetermined times and for a predetermined period corresponding to a cleaning phase of the reflective element 7. In this case, there is no need to use a scraper 13, and the use of a nozzle 15 for projecting a cleaning liquid is optional for the purpose of cleaning the reflective element 7. Additionally, in this variant, the image sensor 3 is positioned relative to the reflective element 7 in such a way that any soiling ejected from the reflective element 7 is prevented from being projected on to the image sensor 3. For this purpose, the image sensor 3 is, for example, kept at a distance from the plane defined by the reflective element 7.

FIGS. 2 to 4 show other embodiments of the viewing device 1 of FIG. 1, for which only the differences from the embodiment of FIG. 1 will be described. The elements of the different embodiments may be combined with one another to create new embodiments.

### SECOND EMBODIMENT

In the second embodiment shown in FIG. 2, the optical conduit 5 has a flared shape, more particularly a conical shape, with the first end 5a having a larger cross section than that of the second end 5b, which is located close to the reflective element 7. The difference in cross section between the first end 5a and the second end 5b of the optical conduit 5 may vary, depending on the angle of view desired for the field of view and on the characteristics of the reflective element 7 and the image sensor 3.

Such an optical conduit 5 may be associated with a reflective element 7 which is not flat and has a degree of curvature in one or more directions, thereby increasing the field of view of the viewing device 1. The reflective element may, for example, have a degree of convexity, thereby providing an optical effect such as a “fish eye” effect, as it is known in English.

In this case, if the cleaning element 11 comprises an element designed to wipe the surface of the reflective element 7, such as the scraper 13, this wiping element has a shape which is complementary to the shape of the reflective element 7, for example a concave shape in the case of a reflective element 7 having a convex shape.

FIG. 2 shows no support for the image sensor 3, because the image sensor 3 may be fixed independently of the optical conduit 5, for example on an element of the vehicle 100 that is fixed relative to the optical conduit 5.

### THIRD EMBODIMENT

FIG. 3 shows a third embodiment, which differs from the embodiment of FIG. 2 in respect of the optical conduit 5. The optical conduit 5 also has a flared shape, but with a rectangular cross section. Additionally, as in the case of FIG. 1, the second end 5b of the optical conduit 5 has a chamfered shape that fits against the reflective element 7 without touching it, and has an opening 50 in the direction D1 of the optical axis of the image sensor 3 to allow the passage of the light rays.

### FOURTH EMBODIMENT

FIG. 4 shows a fourth embodiment, in which the reflective element 7 is moved in translation alternately in one and the other direction, in a reciprocating movement as shown schematically by the arrow 27. The translational movement is provided, for example, by using an electric motor, a connecting rod and crankshaft system, a screw system, and/or an electromagnetic system (not shown). The reflective element 7 may be flat and rectangular in shape, but other shapes of the reflective element 7 may be used, such as a longitudinal convexity or concavity.

Two cleaning elements 11 may be used and placed on either side of the reflection area 29 of the light rays on the reflective element 7. The cleaning elements 11 comprise, for example, a scraper 13 and/or a nozzle 15 for spraying cleaning product, the scraper 13 being positioned between the reflection area 29 and the spray nozzle 15. The other variants of the cleaning elements 11 described above may also be used in this embodiment.

Additionally, in the different embodiments described above, the different elements, and notably the reflective element 7 and the image sensor 3, are arranged so that the light rays are reflected upwards when the viewing device 1 is in the mounted state in the motor vehicle 100. Such an arrangement prevents soiling from reaching the image sensor 3, because of the force of gravity that attracts it in a direction which is different from, and possibly opposed to, the direction leading towards the image sensor 3.

The present invention also relates to a motor vehicle 100. The viewing device 1 may be placed at different locations in the motor vehicle 100, corresponding to different configurations of the implementation of the viewing device 1.

### First Location

In a first configuration shown in FIG. 5, the viewing device 1 is positioned at the rear of the vehicle 100, on the boot, to provide rear viewing from the vehicle when the vehicle 100 is reversing, notably in order to detect obstacles located behind the vehicle 100 and to facilitate parking manoeuvres. The viewing device 1 may also be placed at the rear bumper 102. FIG. 5 also shows schematically the boundaries of the field of view of the viewing device 1, in the form of the line 31.

### Second Location

According to a second configuration shown in FIG. 6, the viewing device 1 is positioned on the front of the vehicle 100, at the radiator grille or at the bumper, to improve forward vision, notably during parking manoeuvres of the vehicle 100 or in conditions of reduced visibility, for example at night in cases where an infrared image sensor is used. The boundaries of the field of view of the viewing device 1 are again shown schematically, by the line 31′.

### Third Location

According to a third configuration shown in FIG. 7, the viewing device 1 is positioned on a side of the vehicle 100, notably in place of, or in addition to, the exterior rear view mirror. The viewing device 1 may be installed equally well on the driver or the passenger side, or on both sides. Locations other than the position of the rear view mirror would also be feasible on the sides of the vehicle 100. The boundaries of the field of view of the viewing device 1 are again shown schematically, by the line 31″. Thus the viewing device 1 provides lateral vision towards the rear of the vehicle 100, notably for the purpose of detecting a vehicle approaching from behind the next lane. The viewing device 1 may also make it possible to overcome the problem of blind spots when a rear view mirror is used, and/or may enable the aerodynamics of the vehicle to be improved by eliminating the rear view mirror or reducing its size.

The viewing device 1 may also be positioned at a rear opening, for example at a rear door or rear window of a utility vehicle or van or on a trailer, such as a trailer of an articulated vehicle or any other kind of trailer such as a caravan.

The viewing device 1 may also be placed in an independent housing to be fixed on a motor vehicle 100. The images captured by the viewing device 1 may be transmitted to a display device of the motor vehicle 100 by wireless communication or by any other means known to those skilled in the art.

The different configurations described above may be combined within the same motor vehicle 100.

Different configurations would also be feasible for controlling the activation of the viewing device 1, that is to say the activation of the image sensor 3, and for controlling the cleaning of the reflective element 7.

### Controlling the Activation of the Viewing Device 1

The viewing device 1 may be continuously activated during the use of the vehicle 100. In this case, the viewing device 1 is activated when the vehicle is started, and the image supplied by the image sensor 3 is displayed continuously or on command when the user selects the display of the image supplied by the image sensor 3.

Alternatively, the viewing device 1 may be activated only when the user actuates a predetermined command, for example a dedicated command, or when reverse gear is engaged, in the case of a rear viewing device 1 for parking assistance. For this purpose, the viewing device 1 is, for example, coupled to a device 103 for engaging the reverse gear of the motor vehicle 100, for example a gearbox, as shown in FIG. 8. The coupling may be direct, or may be via a central unit 105 such as an on-board computer of the motor vehicle 100. The viewing device 100 is then activated when reverse gear is engaged.

### Controlling the Cleaning of the Reflective Element 7

The actuation of the cleaning of the reflective element 7 consists in controlling the drive unit 9 to move the reflective element 7, and if necessary to control the projection of a cleaning liquid and/or compressed air on to the reflective element 7.

This cleaning actuation may be carried out continuously during the use of the viewing device 1, or only at predetermined moments, or only when a dedicated command is issued by the user.

In the case of automatic activation, the cleaning may be carried out at regular time intervals. Alternatively or additionally, additional sensors and/or sensors external to the viewing device 1 may also be used to initiate the activation of the cleaning of the reflective element 7.

### First Configuration

According to a first configuration, the viewing device 1 may be coupled to a rain detection device, used for example to actuate the windscreen wipers, so that cleaning is activated when rain is detected, and the cleaning frequency may also be adjusted according to the amount of rain detected.

### Second Configuration

According to a second configuration, a unit for processing the images detected by the image sensor 3 may be used to determine, on the basis of these images, whether the reflective element 7 needs to be cleaned. For example, if the image is blurred, or if soiling is detected on the reflective element 7, a command is sent to initiate the cleaning of the reflective element 7. The processing unit takes the form of a microcontroller or microprocessor, for example, and may be internal or external to the viewing device 1.

Thus, the viewing device 1 according to the present invention makes it possible, by using a reflective element 7, to avoid the projection of soiling on to the image sensor 3, and thus to avoid any damage of, or obstruction to, the image sensor 3 of the viewing device 1. Additionally, because a movable reflective element 7 is used, the reflective element 7 may be cleaned while still providing normal reflection of the light rays. The cleaning of the reflective element 7 is then “transparent” for the user, that is to say without any impact on viewing quality, and makes it possible to maintain a similar image quality regardless of the environmental or climatic conditions, and notably during the cleaning of the reflective element 7.

1. A viewing device for a motor vehicle, comprising:
an image sensor;
an optical conduit defining an optical input path for light rays;
a reflective element placed so as to reflect the light rays transmitted via the optical conduit towards the image sensor, the optical axis of the image sensor being angularly offset from the optical axis defined by the optical conduit,
wherein the reflective element is mounted so as to be movable, and in that the viewing device further comprises a unit for driving the movement of the reflective element, the movement of the reflective element by the drive unit causing the cleaning of said reflective element.

2. The viewing device according to claim 1, wherein the reflective element is mounted so as to be movable in rotation or in translation, with a reciprocating motion.

3. The viewing device according to claim 2, wherein the reflective element is more extensive than the area of reflection of the light rays that have passed through the optical conduit, and wherein the viewing device comprises an element for cleaning the reflective element, said cleaning element being configured to clean the reflective element outside said area of reflection.

4. The viewing device according to claim 3, wherein the cleaning element is positioned below the area of reflection when the viewing device is in the mounted state on the motor vehicle.

5. The viewing device according to claim 4, wherein the reflective element has the general shape of a disc, and wherein the drive unit is configured to drive the reflective element in rotation around a central axis of the disc.

6. The according to claim 5, wherein the cleaning element comprises at least one element from among:
a scraper designed to come into contact with a portion of the reflective element,
a brush designed to come into contact with a portion of the reflective element,
a device for projecting compressed air on to a portion of the reflective element,
a device for projecting cleaning liquid.

7. The viewing device according to claim 2, wherein the reflective element comprises a hydrophobic treatment, and wherein the drive unit is configured to rotate the reflective element so as to clean any soiling from the reflective element by centrifugal force.

8. The viewing device according to claim 1, wherein the optical conduit has a substantially conical overall shape.

9. The viewing device according to claim 1, wherein the surface of the reflective element has a curvature configured to increase the field of view of the image sensor.

10. The viewing device according to claim 1, wherein the drive unit is configured to put the reflective element into motion when the viewing device is activated, or when a dedicated command is activated by the user.

11. The viewing device according to claim 1, comprising a unit for processing the image detected by the image sensor, configured to detect soiling on the reflective element and to cause the drive unit to be activated to put the reflective element into motion when soiling is detected.

12. The viewing device according to claim 1, wherein the reflective element and the image sensor are arranged so that the light rays are reflected upwards when the viewing device is in the mounted state in the vehicle.

13. The viewing device according to claim 1, wherein the image sensor comprises an infrared sensor and provides night vision.

14. Motor vehicle comprising at least one viewing device according to claim 1.

15. A motor vehicle according to claim 14, wherein the viewing device is a rear view device coupled to a device for engaging the reverse gear of the motor vehicle, the viewing device being activated when the reverse gear is engaged.

16. A motor vehicle according to claim 15, wherein the viewing device is a rear view device, notably located on a lateral side of the motor vehicle.
